(19) United States
(12) Patent Application Publication
(10) Pub. No.: US 2014/0172282 A1
(43) Pub. Date: Jun. 19, 2014

(54) METHOD AND MODULE FOR ESTIMATING AFTER-CHARGE DRIVABLE RANGE OF ELECTRIC VEHICLE AND DRIVING ASSISTANCE DEVICE

(71) Applicant: INDUSTRIAL TECHNOLOGY RESEARCH INSTITUTE, Hsinchu (TW)

(72) Inventors: Shih-An Feng, Hsinchu County (TW); Yi-Chun Lin, Hsinchu County (TW); Yu-Hui Lin, Miaoli County (TW); Syuan-Yi Chen, Changhua County (TW); Chun-Che Chang, Changhua County (TW)

(73) Assignee: INDUSTRIAL TECHNOLOGY RESEARCH INSTITUTE, Hsinchu (TW)

(21) Appl. No.: 13/831,743

(22) Filed: Mar. 15, 2013

(30) Foreign Application Priority Data
Dec. 14, 2012 (TW) 101147607

(51) Int. Cl. G06F 17/00

(52) U.S. Cl. CPC G06F 17/00
USPC 701/117; 701/123

(57) ABSTRACT

A method and module for estimating after-charge drivable range of an electric vehicle and a driving assistant device are provided. The method includes a power supplement location selecting step, a planned charging time determining step, an after-charge total power estimating step, and an after-charge drivable range estimating step. The planned charging time determining step calculates an estimated driving time for arriving at each power supplement location and an estimated charge waiting time, and determines a planned charging time at each power supplement location. The after-charge total power estimating step calculates an estimated power increment of the electric vehicle and an estimated after-charge total power. The after-charge drivable range estimating step calculates an estimated after-charge drivable range of the electric vehicle centering at each power supplement location according to the current driving information and each estimated after-charge total power.

### CROSS-REFERENCE TO RELATED APPLICATION

This application claims the priority benefit of Taiwan application serial no. 101147607, filed on Dec. 14, 2012. The entirety of the above-mentioned patent application is hereby incorporated by reference herein and made a part of this specification.

### TECHNICAL FIELD

The technical field relates to a method and a module for estimating an after-charge drivable range of an electric vehicle and a driving assistance device.

### BACKGROUND

With the global attention on the green energy and environment protection subjects, low-emission or even zero-emission electric vehicle industry will be a development priority in the future transportation equipment. Batteries are an indispensible device for electric vehicles. Therefore, distribution of charging devices and a length of the charging time have influences on convenience of charging the electric vehicles.

For fast-charge of the electric vehicle, it takes at least thirty to forty minutes to charge the battery to 70 percent of its full capacity. Therefore, finding of a power facility and the time spent in charging significantly affect the vehicle users' travel plan, or even affect the willingness to buy electric vehicles in the future.

There are now a relatively small number of charging stations that are unevenly distributed. Therefore, it would be risky to look for a charging station only after the power of the battery decreases to a certain level. In other words, the problem often encountered by the vehicle user is that there is no reachable charging station around when the vehicle needs to be charged; otherwise, the vehicle user has to change the driving path to ensure the vehicle gets charged, which may dampen the interest in the travel.

Having considered the effect caused by the above charging demand, this inventor filed a Taiwan Patent Application Number 100103461 on Jan. 28, 2011, entitled “driving assistance method and system for electric vehicle”, which application was published on Aug. 1, 2012 with a Publication Number 201232488 (hereinafter referred to as “'461 application”).

In this '461 application, a power safe drivable range is displayed once the electric vehicle is powered on, which can address the above problem. The power safe drivable range is defined as a range within which, no matter where the electric vehicle arrives, lacking of electrical power supply would not happen.

### SUMMARY

This inventor conducted further research based on the '461 application to improve the disclosed method and system. This inventor recognized that although the '461 application can dynamically display the power safe drivable range and the power warning driving range, it fails to estimate the after-charge drivable range. Looking for a power supplement location, queuing for charging, and the actual charging time greatly affect the travel arrangement.

Accordingly, a method and a module for estimating an after-charge drivable range of an electric vehicle and a driving assistance device of an electric vehicle are introduced herein, which can select a power supplement location, estimate the time for charging (planned charging time) after the vehicle arrives at each power supplement location, and estimate the after-charge drivable range with each power supplement location as its center (estimated after-charge drivable range) according to a specified time (specified charge-finish time); or estimate the drivable range (estimated after-charge drivable range) after the vehicle arrives at each power supplement location and is charged according to a specified time (specified charging time duration),. The user may arrange the travel in advance according to the estimated drivable range (estimated after-charge drivable range). This can avoid the senseless waiting time and also provide the travel with more flexibility and selectability.

One of exemplary embodiments comprises a method for estimating an after-charge drivable range of an electric vehicle. The method comprises a power supplement location selecting step, a planned charging time determining step, an after-charge total power estimating step, and an after-charge drivable range estimating step. The power supplement location selecting step acquires information associated with at least one power supplement location. The planned charging time determining step calculates an estimated driving time for arriving at each of the at least one power supplement location and calculates an estimated charge waiting time at each of the at least one power supplement location according to current driving information at a current time and the information associated with each of the at least one power supplement location, and determines a planned charging time of the electric vehicle at each of the at least one power supplement location according to a specified time, the specified time being a specified charging time duration or a specified charging finish-time, wherein when the specified time is the specified charging time duration, the planned charging time is equal to the specified charging time duration, and when the specified time is the specified charging finish-time, the planned charging time is a result of a subtraction of the current time, the estimated driving time, and the estimated charging waiting time from the specified charging finish-time. The after-charge total power estimating step calculates a total power of the electric vehicle when arriving at each power supplement location and starts to be charged as an estimated pre-charge total power, calculates an estimated power increment of the electric vehicle at each of the at least one power supplement location according to the planned charging time, and sums the estimated pre-charge total power and the estimated power increment as an estimated after-charge total power of the electric vehicle at each of at least one power supplement location. The after-charge drivable range estimating step calculates an estimated after-charge drivable range of the electric vehicle centering at each of the at least one power supplement location according to the current driving information and the estimated after-charge total power.

The method further comprises modifying the specified time, and repeating the planned charging time determining step, the after-charge total power estimating step, and the after-charge drivable range estimating step according to the modified specified time, and displaying the estimated after-charge drivable ranges obtained according to the specified time and the modified specified time on a display interface.

The method further comprises displaying the estimated driving time, the estimated charge waiting time, and the planned charging time on the display interface.

Another exemplary embodiment comprises an after-charge drivable range estimating module for an electric vehicle. The estimating module comprises a planned charging time determining unit, an after-charge total power estimating unit, and an after-charge drivable range estimating unit. The planned charging time determining unit receives information associated with at least one power supplement location, a current time, current driving information and a specified time, calculates an estimated driving time for the electric vehicle to arrive at each of the at least one power supplement location, calculates an estimated charge waiting time at each of the at least one power supplement location, and determines a planned charging time of the electric vehicle at each of the at least one power supplement location according to the information associated with each of the at least one power supplement location and the current driving information. The after-charge total power estimating unit receives the planned charging time, calculates an estimated power increment of the electric vehicle at each of the at least one power supplement location according to the planned charging time, calculates a total power of the electric vehicle when the electric vehicle arrives at each of the at least one power supplement location and starts to be charged as an estimated pre-charge total power, and sums the estimated pre-charge total power and the estimated power increment to obtain an estimated after-charge total power of the electric vehicle at each of at least one power supplement location. The after-charge drivable range estimating unit receives the estimated after-charge total power and calculates an estimated after-charge drivable range of the electric vehicle centering at each of the at least one power supplement location.

In the module, the planned charging time is determined based on the specified time that is specified by a user. The specified time is a specified charging time duration or a specified charging finish-time. When the specified time is the specified charging time duration, the planned charging time is equal to the specified charging time duration. When the specified time is the specified charging finish-time, the planned charging time is a result of a subtraction of the current time, the estimated driving time, and the estimated charging waiting time from the specified charging finish-time.

Another exemplary embodiment comprises an electric vehicle driving assistance device comprising a micro-controller unit. The micro-controller unit comprises a vehicle dynamic analysis unit, an environment variable detecting unit, a power supply facility selecting unit, and the above electric vehicle after-charge drivable range estimating module. The vehicle dynamic analysis unit detects the status of the electric vehicle itself to obtain the vehicle dynamic information, battery information of the electric vehicle. The environment variable detecting unit detects the status of the environment in which the electric vehicle is located to obtain the positioning information, map information, and traffic information. The power supply facility selecting unit receives the vehicle dynamic information, the battery information, the positioning information, the map information and the traffic information to thereby set a selecting range, and acquires information associated with at least one power supplement location within the selecting range.

In the assistance device, the vehicle dynamic information comprises vehicle speed, triaxle acceleration, triaxle angular velocity and electromagnetic direction of the electric vehicle for computing a direction and energy consumption of the vehicle.

The assistance device further comprises a display interface which displays the map information, the information associated with the at least one power supplement location, the estimated after-charge drivable range calculated by the after-charge drivable range estimating unit in a consolidated manner. The assistance device further comprises a human-machine interactive interface which allows the user to input various parameters such as the specified time or allows the user to continuously inquire different after-charge drivable range after the at least one power supplement location is specified. The human-machine interactive interface may embedded in the display interface or may be separated from the display interface while connected with the display interface.

Several exemplary embodiments accompanied with figures are described in detail below to further describe the disclosure in detail.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a flow chart of a method for estimating an after-charge drivable range of an electric vehicle according to one embodiment.

FIG. 2 illustrates a flow chart of step S100 of FIG. 1.

FIG. 3 illustrates a flow chart of step S200 of FIG. 1.

FIG. 4 illustrates a flow chart of step S300 of FIG. 1.

FIG. 5A to 5C illustrates various scenarios of setting a selecting range, where FIG. 5A illustrates that the user sets the selecting range, FIG. 5B illustrates that the selecting range is determined according to location of the vehicle and vehicle dynamic information of the electric vehicle, and FIG. 5C illustrates that the selecting range is determined according to location, driving direction and vehicle dynamic information of the electric vehicle.

FIG. 6 illustrates an example of a display interface of an electric vehicle after-charge drivable range estimating method according to one embodiment.

FIG. 7 illustrates another example of a display interface of an electric vehicle after-charge drivable range estimating method according to one embodiment.

FIG. 8 illustrates an example of an electric vehicle after-charge drivable range estimating method according to one embodiment.

FIG. 9 illustrates a block diagram of an after-charge drivable range estimating module according to one embodiment.

FIG. 10 is a block diagram illustrating an electric vehicle driving assistance device that utilizes the above electric vehicle after-charge drivable range estimating module as well as its peripheral devices.

### DESCRIPTION OF THE EMBODIMENTS

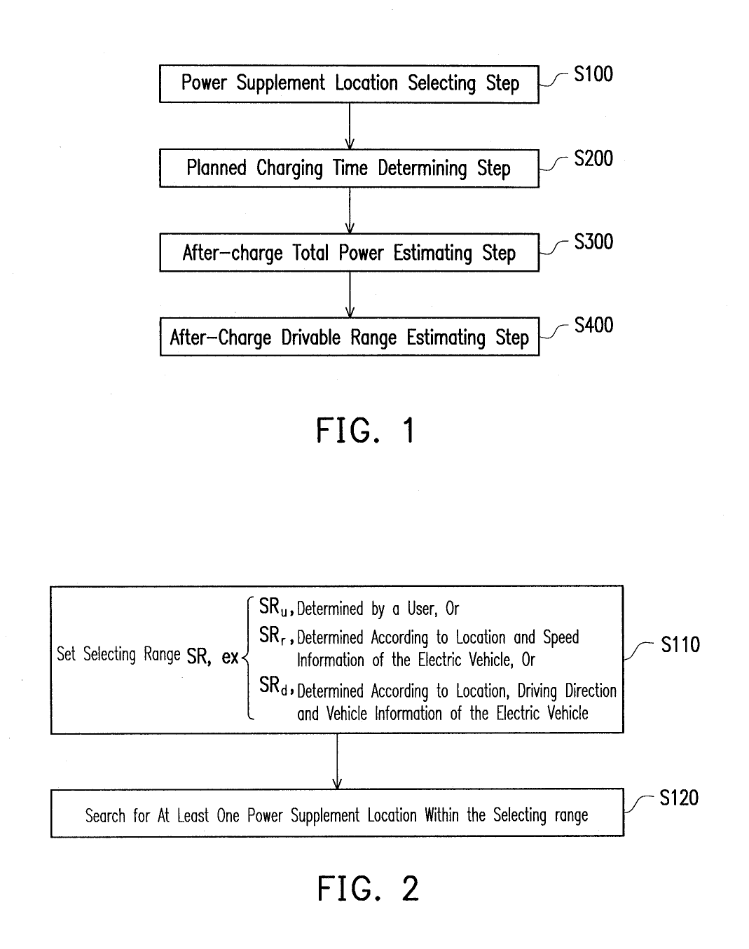

FIG. 1 illustrates a flow chart of a method for estimating an after-charge drivable range of an electric vehicle according to one embodiment.

One embodiment of the electric vehicle after-charge drivable range estimating method includes a power supplement location selecting step S100, a planned charging time determining step S200, an after-charge total power estimating step S300, and an after-charge drivable range estimating step S400.

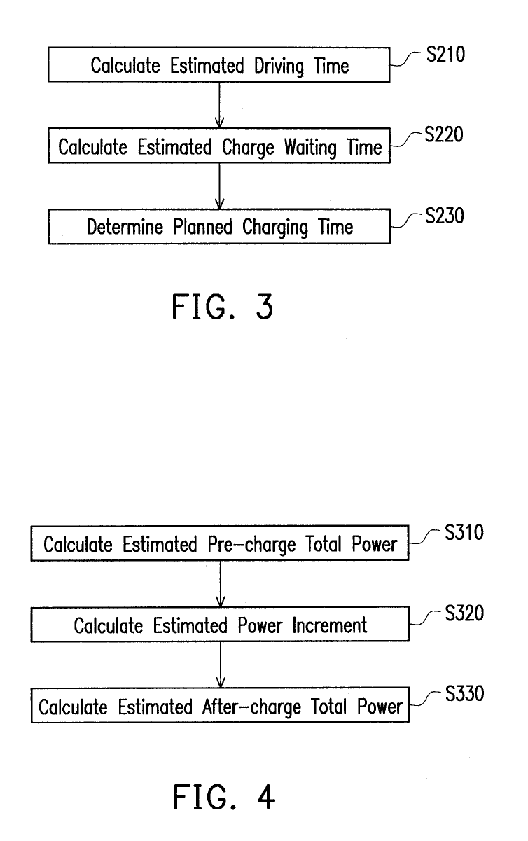

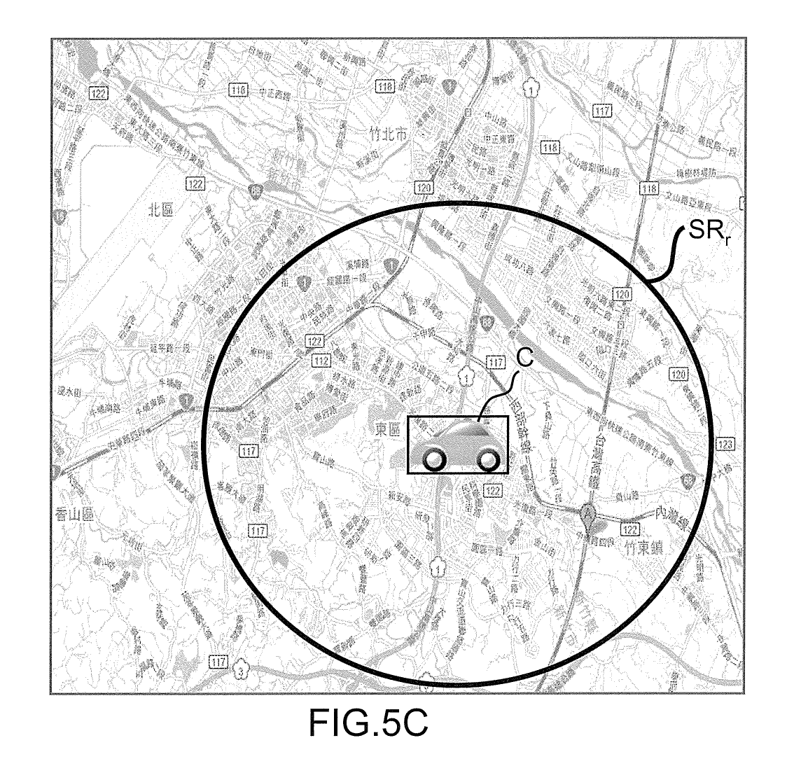

The power supplement location selecting step S100 acquires information of at least one power supplement location Ch. Here, the power supplement location Ch is, for example, a charging station. As shown in FIG. 2, the step S100 includes setting a selecting range SR (step S110) and searching for the power supplement location Ch within the selecting range SR (step S120). The selecting range SR may be specified by a user and may be, for example, SRu (as shown in FIG. 5A); the selecting range SR may also be determined according to the location, driving direction, dynamic information of the electric vehicle C (if the travel is directional) and may be, for example, SRd (as shown in FIG. 5B); and the selecting range SR may further be determined according to the location and speed information of the electric vehicle C (if the travel is nondirectional and random) and may be, for example, SRr (as shown in FIG. 5C).

There may be one power supplement location Ch (e.g. Ch1) or more than one power supplement location (e.g. Ch1, Ch2 . . . ) within the selecting range SR. Therefore, the phrase “at least one power supplement location Ch” is used in the following description. The power supplement location selecting step S100 was described in detail in a previous patent application of the same inventor, i.e. the '461 application and, therefore, a detailed explanation thereof is not repeated herein.

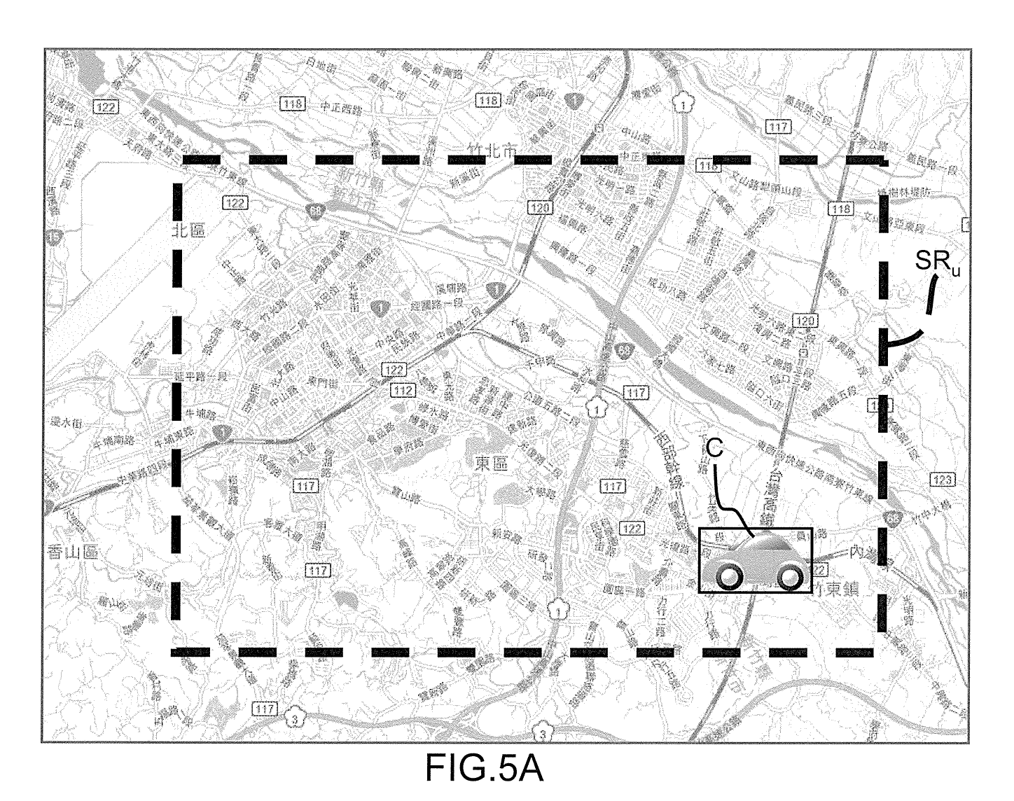

The planned charging time determining step S200 includes the following steps of calculating according to current driving information at a current time Tn and information associated with the power supplement location Ch: as shown in FIG. 3, a step S210 of calculating an estimated driving time, a step S220 of calculating an estimated charge waiting time, and a step S230 of determining a planned charging time.

The step S210 calculates an estimated driving time td for arriving at each power supplement location Ch according to the current driving information at the current time Tn, including, for example, vehicle dynamic information (this vehicle dynamic information is used to calculate the driving direction and power consumption of the electric vehicle, for example, including information such as vehicle speed, triaxle acceleration, triaxle angular velocity and electromagnetic direction), battery information, positioning information, map information and traffic information, and information associated with the power supplement location Ch, for example, the position, service time, number of charging seats, average waiting time (queue time+time for going through formalities), and revered time. In addition, the current driving information may also include vehicle weight information.

If there is only one power supplement location Ch1 within the selecting range SR, then only one estimated driving time td1 needs to be calculated. If there are two or more power supplement locations Ch (Ch1, Ch2 . . . ), the estimated driving time td (td1, td2 . . . ) for arriving at each of the power supplement locations Ch is calculated. The information associated with the power supplement locations Ch may also include the number of vehicles in queue and the number of reservations. The battery information may include battery usage information, remaining capacity information and battery degradation information. The map information may include road type information and landform information. The traffic information may include real-time road condition information and vehicle flux information. The real-time road condition information may, for example, include traffic accident information and road construction information.

The step S220 calculates the estimated charge waiting time tw after the electric vehicle arrives at each of the at least one power supplement location Ch according to the calculated estimated driving time td and the information associated with the power supplement location Ch. If there is only one power supplement location Ch (Ch1), the estimated charge waiting time tw (tw1) is calculated. If there are two or more power supplement locations Ch (Ch1, Ch2 . . . ), then the estimated charge waiting time tw (tw1, tw2 . . . ) at each power supplement location is calculated. For example, the estimated charge waiting time tw may be calculated by summing the average waiting time and the reserved time at each power supplement location Ch, or by multiplying the average waiting time with the sum of the number of vehicles in queue and the number of reservations, i.e. the estimated charge waiting time tw=average waiting time×(the number of vehicles in queue+the number of reservations).

The step S230 determines the planned charging time tp of the electric vehicle C at each of the at least one power supplement location Ch according to a specified time Tspec. The specified time Tspec may be a specified charging time duration tg or a specified charging finish-time Tf. If the specified time Tspec is the specified charging time duration tg, then each planned charging time tp is equal to the specified charging time duration tg. If the specified time Tspec is a specified charging finish-time Tf, then each planned charging time tp is equal to the result of subtracting the current time Tn, estimated driving time td and estimated charging waiting time tw from the specified charging finish-time Tf.

The specified time Tspec may be specified by the user. That is, the user may specify a specified charging time duration tg which applies to each of the at least one power supplement location Ch. In later steps (discussed in detail in steps S300, S400 below), the time at which the specified charging time duration tg completes at each power supplement location Ch is calculated and an drivable range (estimated after-charge drivable range R) of the electric vehicle C at that charge-complete time around each power supplement location Ch is estimated. Here, the time at which the specified charging time duration tg completes is one resulted by summing the current time Tn, estimated driving time td, estimated charging waiting time tw, and the specified charging time duration tg. The user may also specify a charge finish-time Tf. In later steps (discussed in detail in steps S300, S400 below), the allowable charging time (planned charging time tp) at each power supplement location Ch limited by the specified charging finish-time Tf is calculated, and an drivable range (estimated after-charge drivable range R) of the electric vehicle C at the specified charging finish-time Tf around each power supplement location Ch is estimated.

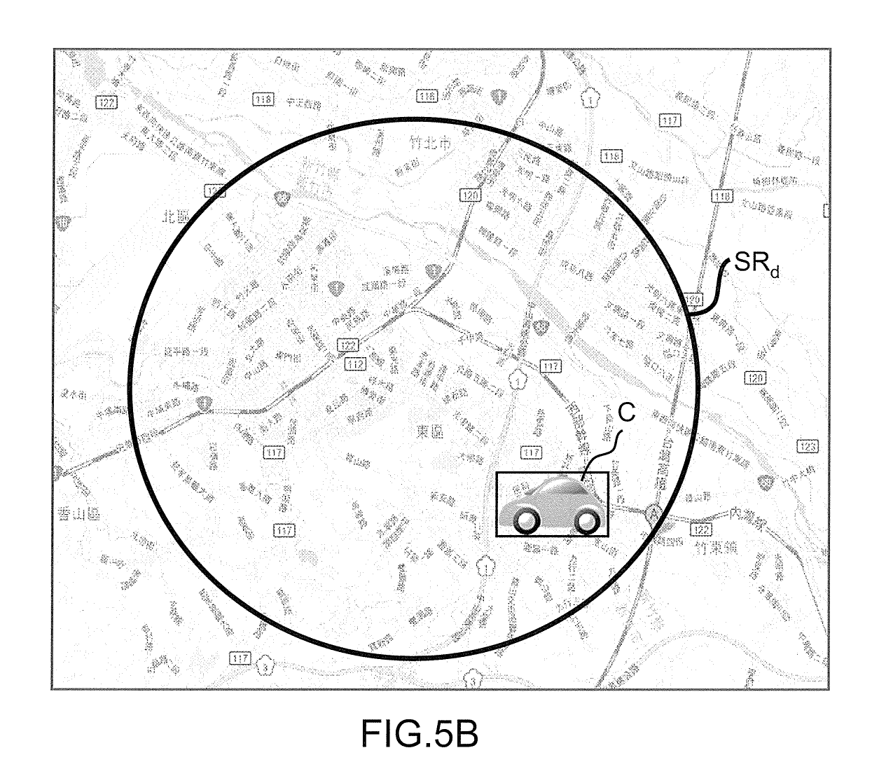

The after-charge total power estimating step S300 includes the following steps of calculating: as shown in FIG. 4, a step S310 of estimating pre-charge total power, a step S320 of estimating power increment, and a step S330 of estimating after-charge total power S330.

The step S310 calculates a total power of the electric vehicle C when arriving at each power supplement location Ch and starting to charge as the estimated pre-charge total power Bs according to the current driving information and the above information associated with each power supplement location Ch. For example, the estimated driving time td and estimated charge waiting time tw that can be obtained at step S210. With the td, tw obtained at step S210 and further with the current driving information, the total power of the electric vehicle C when arriving at each power supplement location Ch and starting to charge (estimated pre-charge total power Bs) may be calculated.

The step S320 calculates an estimated power increment AB of the electric vehicle C at each power supplement location Ch according to each planned charging time tp determined at step S230. For example, the power increment (i.e. estimated power increment ΔB) at each power supplement location Ch may be estimated according to each planned charging time tp, the battery information of the current driving information, such as, the battery condition information, remaining capacity information, battery degradation information, and the information associated with the power supplement location Ch, such as, specification of the charging facility (e.g. charging capability, charging current).

The step S330 sums each estimated pre-charge total power Bs and a corresponding estimated power increment ΔB, and the summing result is considered as the estimated after-charge total power Bf of the electric vehicle C at each power supplement location Ch.

The after-charge drivable range estimating step S400 calculates the estimated after-charge drivable range R of the electric vehicle C centering at each power supplement location Ch according to the current driving information and each estimated after-charge total power Bf. If there are two or more power supplement locations Ch, for example, Ch1, Ch2 . . . , then the estimated after-charge drivable range R (R1, R2 . . . ) around each power supplement location Ch (Ch1, Ch2 . . . ) is calculated. Estimating a drivable range centering at an electric vehicle C under a certain remaining power is known in the art. It is noted that, in the embodiment discussed herein, the range within which the electric vehicle can safely drive back is estimated with each power supplement location Ch as its center. When the landform and traffic factors are taken into account, the resulted range is not necessarily a perfect circle.

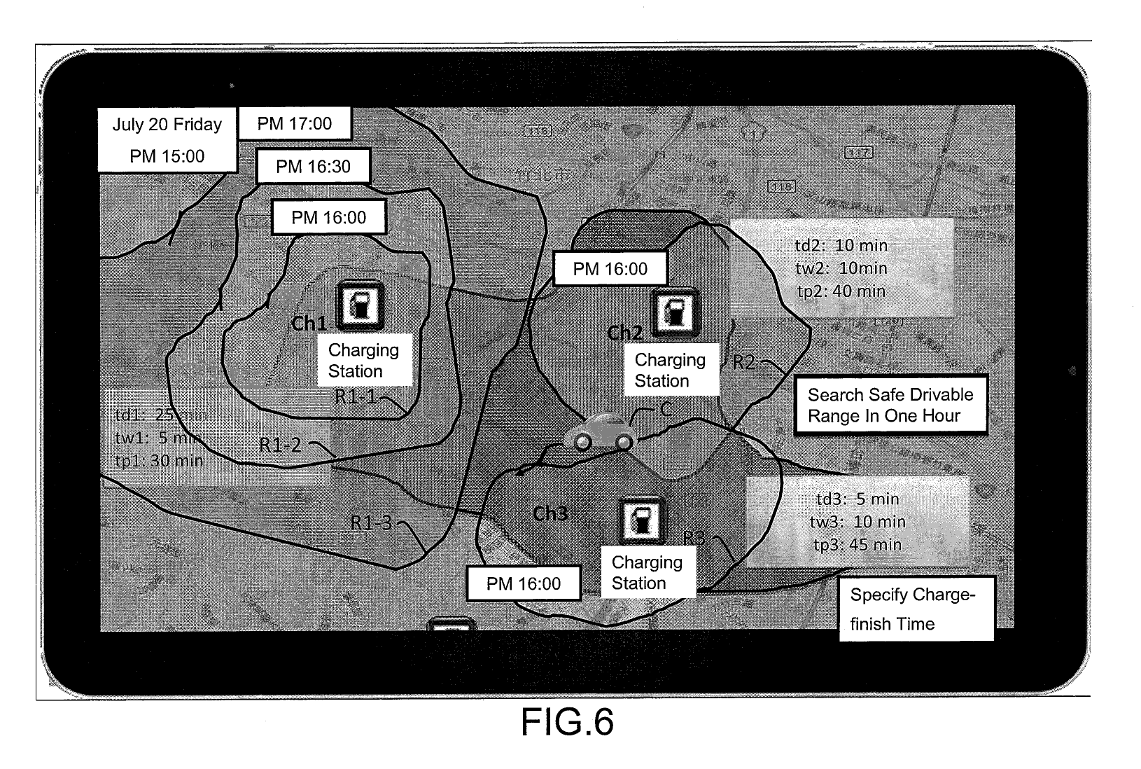

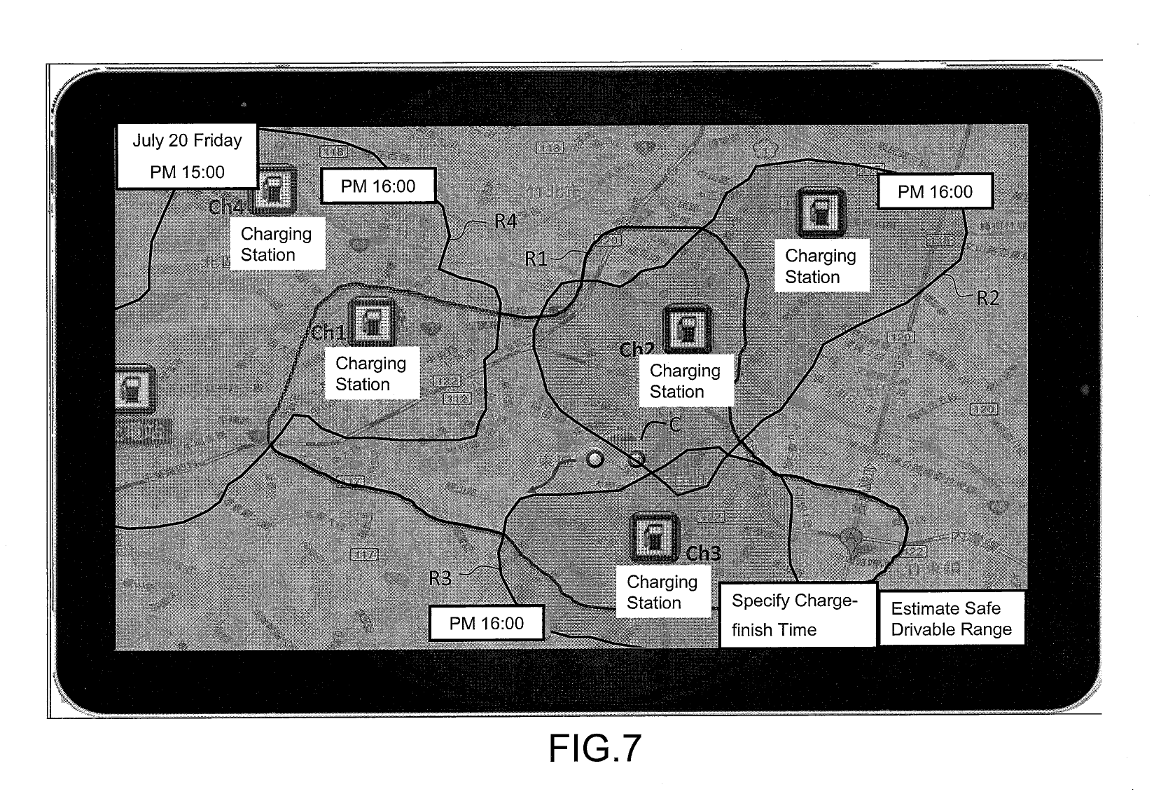

In the above after-charge drivable range estimating method, the estimated after-charge drivable range R may be displayed through a display interface such as a vehicle display. In addition, the specified time Tspec, i.e. the specified charge finish-time Tf or the specified charging time duration tg, may be displayed through the display interface together. Furthermore, each estimated driving time td, each estimated charge waiting time tw, and each planned charging time tp may also be displayed through the display interface, as shown in FIG. 6. The display interface may be further embedded with a human-machine interactive interface which allows for user-input directly through the display interface. Alternatively, the display interface and the human-machine interactive interface may be two separate elements that are interconnected such that the condition parameters inputted through the human-machine interactive interface and calculation results are displayed on the display interface. The specified time Tspec may be set by a user in various manners such as key-in, touch input or touch-drag (as shown in FIG. 7, the user drags to increase or decrease the specified finish-time Tf). It should be understood that the method also allows the user to directly drag the estimated after-charge drivable range R, and the method reversely estimates the estimated after-charge total power Bf according to the estimated after-charge drivable range R after the user's drag. The estimated power increment ΔB after the user's drag can then be obtained according to the estimated after-charge total power Bf after the user's drag. The planned charging time tp after the user's drag can then be calculated according to the estimated power increment ΔB after the user's drag. That is, the charging time needed at each power supplement location may be calculated according to the range desired by the user, which greatly facilitates the user planning the travel.

Referring to FIG. 7, the user may obtain information associated with at least one power supplement location Ch (e.g. Ch1, Ch2, Ch3, Ch4) at the current time Tn, e.g. Friday PM 15:00, and specify the charging finish-time Tf to, for example, 16:00. As such, according to the above method, the user may know the estimated after-charge drivable range R1 centering at the power supplement location Ch1 after the electric vehicle C arrives at the power supplement location Ch1 and waits and is charged by the specified time 16:00. Similarly, the user may also know the estimated after-charge drivable range R2 if the electric vehicle C is charged at the power supplement location Ch2 by the specified time 16:00, and the estimated after-charge drivable range R3, R4 when it is charged at the power supplement location Ch3, Ch4. The above current time Tn 15:00 and the specified charging finish-time Tf 16:00 are merely illustrative rather than restrictive.

In addition, the user may also specify the charging time duration tg to, for example, 30 minutes. Then, according to the above method, the user may know the time Tf1 by which the electric vehicle C will have been charged for the specified time duration tg after it arrives the power supplement location Ch1 and waits for a period of time (because the estimated driving time td1 and the estimated charging waiting time tw1 are also computable, and the charging time duration tg is known, the charging finish-time Tf1 is determinative, i.e. Tf1=Tn+td1+tw1+tg), and the user may also know the estimated after-charge drivable range R1 centering at the power supplement location Ch1 at the charging finish-time Tf1. Similarly, the user may also know the time Tf2 by which the electric vehicle. C will have been charged for the specified charging time duration tg, and the estimated after-charge drivable range R2. The above specified charging time duration tg of 30 minutes is merely illustrative rather than restrictive.

As such, the above method facilitates the user estimating the charging condition at each power supplement location and the after-charge drivable range and, therefore, enables the user to arrange the travel in advance.

After setting the above specified time Tspec, the user may also modify the specified time. For example, the above specified time is Tspec-1, the specified time after modified becomes Tspec-2, and, according to the modified specified time Tspec-2, the method repeats the planned charging time determining step S200, the after-charge total power estimating step S300 and the after-charge drivable range estimating step S400 to calculate each estimated the modified after-charge drivable range R-2 (here, “-2” represents that the drivable range R-2 is calculated according to the specified time Tspec-2) according to the modified estimated specified time Tspec-2 and display the drivable range R-2 on the display interface. In another embodiment, the drivable range R-2 calculated according to the specified time Tspec-2 and the drivable range R-1 calculated according to the specified time Tspec-1 can be displayed on the display interface together or alternatively, which facilitates the user understanding the estimates from the diagram. It is to be understood that the specified time may be modified multiple times to become, for example, Tspec-2, Tspec-3 . . . , and the estimated drivable ranges R-2, R-3 . . . are displayed on the display interface together or alternatively. As sown in FIG. 6, the current time Tn is 15:00, and the specified time Tspec-1 is the specified charge-finish time TF-1 16:00. The estimated driving time td1 to td3, the estimated charge waiting time tw1 to tw3, and the planned charging time tp1 to tp3 limited by the specified charge-finish time Tf 16:00 are displayed at the three power supplement locations Ch1, Ch2, Ch3, respectively. If the user finds that the estimated charge waiting time tw1 (5 minutes) at the power supplement location Ch1 is the shortest, the user may further inquire with respect to the power supplement location Ch1 about the estimated after-charge drivable range R1-2, R1-3 according to the specified charge-finish time Tf-2 (16:30) and the specified time Tf-3 (17:00), and the estimated drivable ranges R1-2, R1-3 and the drivable range R1-1 for specified time Tf-1 16:00 can be displayed together.

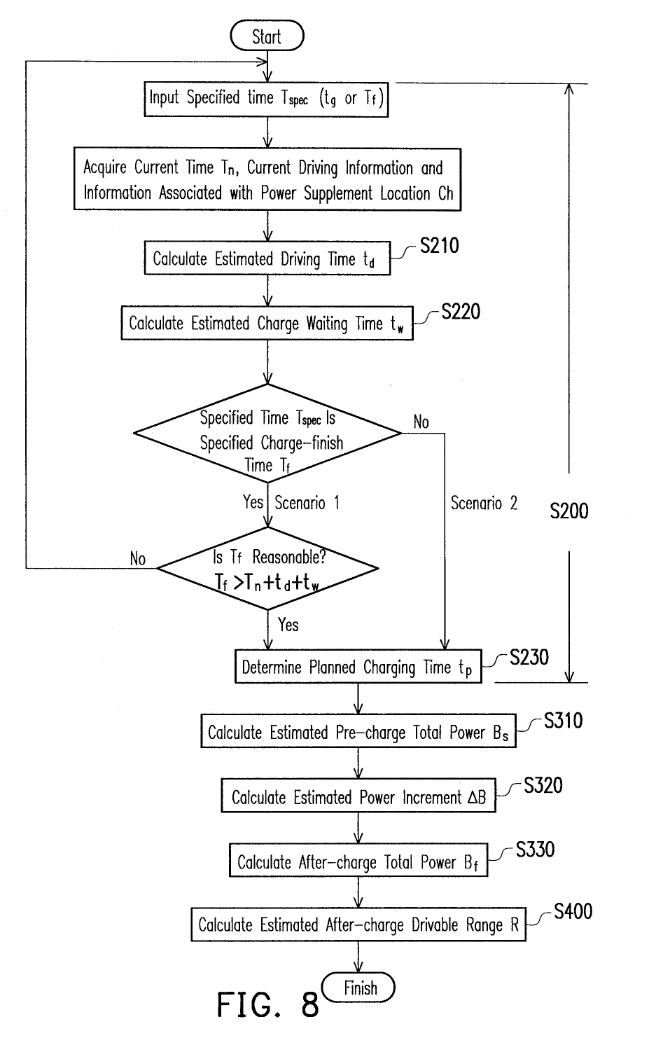

FIG. 8 illustrates an example of the electric vehicle after-charge drivable range estimating method. The step S200 covers all operations from inputting specified time Tspec to determining planned charging time tp. If the specified time Tspec is the specified charging finish-time Tf, it belongs to the scenario 1 and the method proceeds along the flow of scenario 1. If the specified time Tspec is the specified charging time duration tg, it belongs to the scenario 2 and the method proceeds along the flow of scenario 2. In FIG. 8, the inventor considers that inputting the specified charging finish-time Tf by the user may lead to an unreasonable result. Therefore, a determining step is added after the estimated driving time td and estimated charge waiting time tw are calculated. This determining step determines whether Tf is greater than the sum of Tn, td, and tw. A subtraction of Tn, td, tw from Tf results in the planned charging time tp. If the calculated charging time is a negative value or too small, it is unreasonable. If it is unreasonable, the method returns to the step of inputting the specified time Tspec. In addition, if there is a preset reasonable charging time threshold, this preset value may be considered in this determining step, i.e. it is determined whether Tf-Tn-td-tw>preset value and whether the charging time is reasonable according to this preset value.

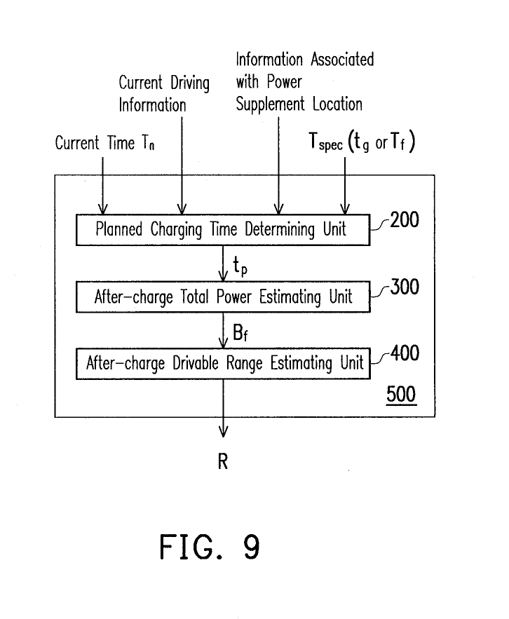

FIG. 9 illustrates an after-charge drivable range estimating module according to one embodiment.

The electric vehicle after-charge drivable range estimating module 500 includes a planned charging time determining unit 200, an after-charge total power estimating unit 300, and an after-charge drivable range estimating unit 400.

The planned charging time determining unit 200 receives information associated with at least one power supplement location Ch, the current time, the current driving information, and a specified time Tspec, and performs the step S200 to calculate the estimated driving time td that the electric vehicle C needs to arrive at each of the at least one power supplement location Ch and the estimated charge waiting time tw at each power supplement location Ch, and to determine the planned charging time tp at each power supplement location Ch.

Each planned charging time tp is determined based on the specified time Tspec such as the specified time specified by the user (e.g. the specified charging time duration tg or the specified charging finish-time Tf). When the specified time Tspec is the specified charging time duration tg, then each planned charging time tp is equal to the specified charging time duration tg. When the specified time Tspec is the specified charging finish-time Tf, then each planned charging time tp is a result of the subtraction of the current time Tn, the estimated driving time td, and the estimated charging waiting time tw from the specified charging finish-time Tf.

The after-charge total power estimating unit 300 receives each planned charging time tp and performs the step S300 to calculate the estimated power increment ΔB of the electric vehicle at each power supplement location Ch according to each planned charging time tp and calculate the estimated pre-charge total power Bs of the electric vehicle C when the electric vehicle C arrives at each power supplement location and starts to be charged. Each estimated pre-charge total power Bs is added with a corresponding estimated power increment ΔB to obtain the estimated after-charge total power Bf of the electric vehicle C at each power supplement location Ch.

The after-charge drivable range estimating unit 400 receives each estimated after-charge total power Bf and performs the step S400 to calculate the electric vehicle C's estimated after-charge drivable range R centering at each power supplement location Ch.

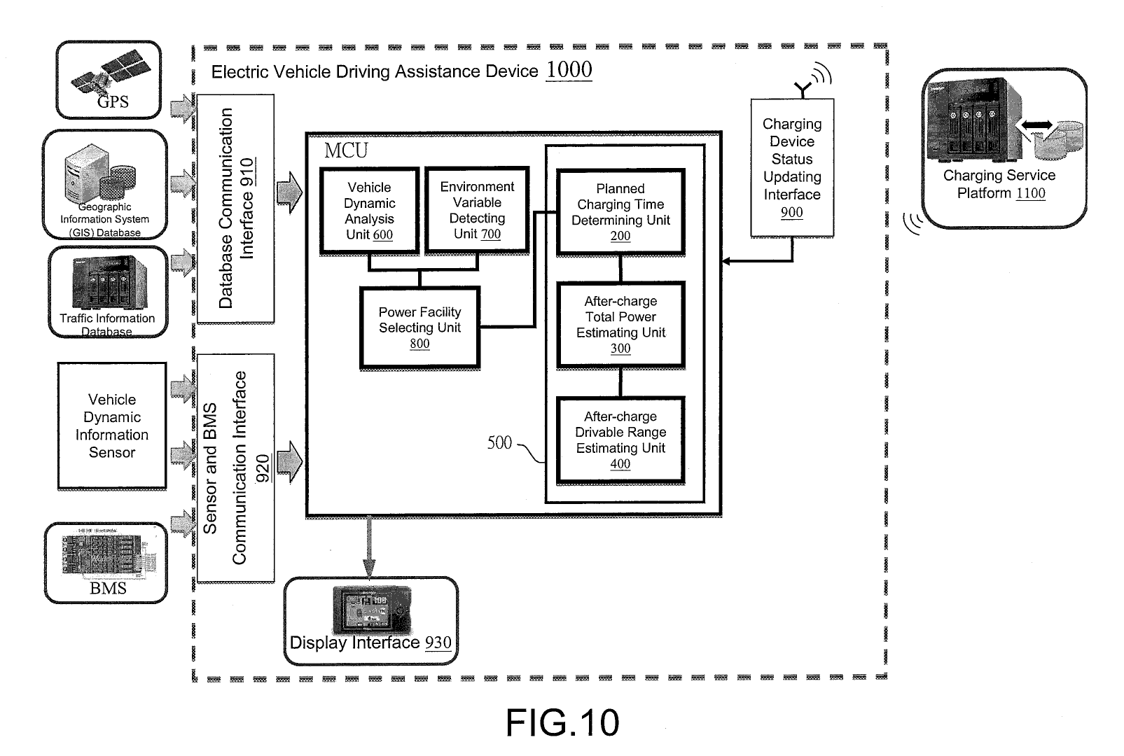

FIG. 10 illustrates an electric vehicle driving assistance device that utilizes the after-charge drivable range estimating module 500 of the electric vehicle as well as its peripheral devices.

The electric vehicle driving assistance device 1000 includes a micro-controller unit MCU. The micro-controller unit MCU includes a vehicle dynamic analysis unit 600, an environment variable detecting unit 700, a power supply facility selecting unit 800, and the above after-charge drivable range estimating module 500.

The vehicle dynamic analysis unit 600 and the environment variable detecting unit 700 are the common vehicle information collecting module.

The vehicle dynamic analysis unit 600 detects the status of the electric vehicle C itself to obtain the vehicle dynamic information, battery information of the electric vehicle, which may be obtained, for example, by using vehicle dynamic information sensors installed on the electric vehicle such as gyroscope, triaxle accelerometer and electronic compass as well as battery management system (BMS).

The environment variable detecting unit 700 detects the status of the environment in which the electric vehicle C is located to obtain the positioning information, map information, traffic information, or the like. For example, the positioning information may be obtained by using a global positioning system (GPS) installed on the electric vehicle; the map information may be obtained by communicating with a geographic information system (GIS) database; and the real-time and history traffic information may be obtained by communicating with a traffic information database.

The power supply facility selecting unit 800 performs the above step S100. The power supply facility selecting unit 800 receives the above vehicle dynamic information, battery information, positioning information, map information and traffic information to thereby set a selecting range SR (e.g. SRd of FIG. 5B, SRr of FIG. 5C). Alternatively, the user sets the selecting range SR (e.g. SRu of FIG. 5A). The power supply facility selecting unit 800 also acquires information associated with at least one power supplement location Ch within the selecting range SR.

The electric vehicle driving assistance device 1000 may further include a charging device status updating interface 900 for receiving the information associated with each power supplement location Ch, which includes, for example, the position, the service time, the number of the charging seats, the average waiting time, the reserved time, or the like, and may further include the number of vehicles in queue, the number of reservations, or the like. The charging device status updating interface 900 is adapted to communicate with a charging service platform 1100 to obtain the information associated with each power supplement location Ch. The charging service platform 1100 may be a cloud database which continuously or intermittently updates the status of each charging device.

The electric vehicle driving assistance device 1000 may further include a database communication interface 910, a sensor and BMS communication interface 920, a display interface 930. Any one of these interfaces may be embedded in the electric vehicle driving assistance device 1000. Alternatively, these interfaces may utilize the existing interfaces on the electric vehicle C rather than being embedded in the electric vehicle driving assistance device 1000. As described above, the display interface 930 may be further embedded with a human-machine interactive interface (not shown), which allows for user-input directly through the display interface 930. In addition, the display interface 930 and the human-machine interactive interface (not shown) may be two separate elements that are interconnected such that the condition parameters inputted through the human-machine interactive interface and calculation results are displayed on the display interface.

The database communication interface 910 receives and outputs the positioning information, map information and traffic information to the environment variable detecting unit 700. The sensor and BMS communication interface 920 receives and outputs the vehicle dynamic information and battery information to the vehicle dynamic analysis unit 600. The display interface 930 displays the map information, the information associated with the power supplement location Ch, each estimated after-charge drivable range R calculated by the after-charge drivable range estimating unit 400 in a consolidated manner.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

1. A method for estimating an after-charge drivable range of an electric vehicle, comprising:
a power supplement location selecting step which uses a charging device status updating interface to acquire information associated with at least one power supplement location;
a planned charging time determining step which calculates uses a micro-controller unit(MCU) to calculate an estimated driving time for arriving at each of the at least one power supplement location and to calculate an estimated charge waiting time at each of the at least one power supplement location according to current driving information at a current time and the information associated with each of the at least one power supplement location, and to determine a planned charging time of the electric vehicle at each of the at least one power supplement location according to a specified time, the specified time being a specified charging time duration or a specified charging finish-time, wherein when the specified time is the specified charging time duration, the planned charging time is equal to the specified charging time duration, and when the specified time is the specified charging finish-time, the planned charging time is a result of a subtraction of the current time, the estimated driving time, and the estimated charging waiting time from the specified charging finish-time;
an after-charge total power estimating step which uses the MCU to calculate a total power of the electric vehicle when arriving at each power supplement location and starting to be charged as an estimated pre-charge total power, to calculate calculates an estimated power increment of the electric vehicle at each of the at least one power supplement location according to the planned charging time, and to sum the estimated pre-charge total power and the estimated power increment as an estimated after-charge total power of the electric vehicle at each of at least one power supplement location; and
an after-charge drivable range estimating step which uses the MCU to calculate an estimated after-charge drivable range of the electric vehicle centering at each of the at least one power supplement location according to the current driving information and the estimated after-charge total power.

2. The method for estimating the after-charge drivable range of the electric vehicle according to claim 1, further comprising displaying the estimated after-charge drivable range on a display interface.

3. The method for estimating the after-charge drivable range of the electric vehicle according to claim 2, wherein the specified time is displayed on the display interface.

4. The method for estimating the after-charge drivable range of the electric vehicle according to claim 3, further comprising displaying the estimated driving time, the estimated charge waiting time, and the planned charging time on the display interface.

5. The method for estimating the after-charge drivable range of the electric vehicle according to claim 3, wherein the specified time is set by a user in a key-in, touch input, or touch-drag manner.

6. The method for estimating the after-charge drivable range of the electric vehicle according to claim 2, further comprising:
setting the estimated after-charge drivable range by a user;
calculating the estimated after-charge total power after the setting according to the set estimated after-charge drivable range;
calculating the estimated power increment after the setting according to the estimated after-charge total power after the setting; and
calculating the planned charging time after the setting according to the estimate power increment after the setting.

7. The method for estimating the after-charge drivable range of the electric vehicle according to claim 6, wherein setting the estimated after-charge drivable range is performed by a user in a key-in, touch input, or touch-drag manner.

8. The method for estimating the after-charge drivable range of the electric vehicle according to claim 1, wherein the specified time is set by a user.

9. The method for estimating the after-charge drivable range of the electric vehicle according to claim 1, further comprising:
modifying the specified time, and repeating the planned charging time determining step, the after-charge total power estimating step, and the after-charge drivable range estimating step according to the modified specified time; and
displaying the estimated after-charge drivable ranges obtained according to the specified time and the modified specified time on a display interface.

10. The method for estimating the after-charge drivable range of the electric vehicle according to claim 1, wherein the information associated with at least one of the power supplement location comprises:
position, service time, number of charging seats, average waiting time and reserved time.

11. The method for estimating the after-charge drivable range of the electric vehicle according to claim 10, wherein the information associated with at least one of the power supplement location further comprises number of vehicles in queue and number of reservations.

12. The method for estimating the after-charge drivable range of the electric vehicle according to claim 1, wherein when the specified time is the specified charging time duration, a time at which the planned charge time completes is one resulted by summing the current time, the estimated driving time, the estimated charging waiting time, and the specified charging time duration.

13. The method for estimating the after-charge drivable range of the electric vehicle according to claim 1, wherein the current driving information comprises: vehicle dynamic information, battery information, positioning information, map information and traffic information.

14. The method for estimating the after-charge drivable range of the electric vehicle according to claim 13, wherein the vehicle dynamic information comprises vehicle speed, triaxle acceleration, and triaxle angular velocity of the electric vehicle, the battery information comprises battery usage information, remaining capacity information and battery degradation information, the map information comprises road type information and landform information, and the traffic information comprises real-time road condition information and vehicle flux information.

15. The method for estimating the after-charge drivable range of the electric vehicle according to claim 14, wherein the real-time road condition information comprises traffic accident information and road construction information.

16. The method for estimating the after-charge drivable range of the electric vehicle according to claim 13, wherein the current driving information further comprises vehicle weight information.

17. The method for estimating the after-charge drivable range of the electric vehicle according to claim 1, wherein the power supplement location selecting step comprises:
setting a selecting range; and
searching for the at least one power supplement location within the selection range.

18. The method for estimating the after-charge drivable range of the electric vehicle according to claim 17, wherein setting the selecting range comprises setting the selecting range by a user.

19. The method for estimating the after-charge drivable range of the electric vehicle according to claim 17, wherein setting the selecting range comprises determining the selecting range according to a location and vehicle dynamic information of the electric vehicle.

20. The method for estimating the after-charge drivable range of the electric vehicle according to claim 17, wherein setting the selecting range comprises determining the selecting range according to a location, driving direction and vehicle dynamic information of the electric vehicle.

21. An after-charge drivable range estimating module for an electric vehicle, comprising:
a planned charging time determining unit which receives information associated with at least one power supplement location, a current time, current driving information and a specified time, calculates an estimated driving time for the electric vehicle to arrive at each of the at least one power supplement location, calculates an estimated charge waiting time at each of the at least one power supplement location, and determines a planned charging time of the electric vehicle at each of the at least one power supplement location according to the info nation associated with each of the at least one power supplement location and the current driving information;
an after-charge total power estimating unit which receives the planned charging time, calculates an estimated power increment of the electric vehicle at each of the at least one power supplement location according to the planned charging time, calculates a total power of the electric vehicle when arriving at each of the at least one power supplement location and starting to be charged as an estimated pre-charge total power, and sums the estimated pre-charge total power and the estimated power increment to obtain an estimated after-charge total power of the electric vehicle at each of the at least one power supplement location; and
an after-charge drivable range estimating unit which receives the estimated after-charge total power and calculates an estimated after-charge drivable range of the electric vehicle centering at each of the at least one power supplement location.

22. The after-charge drivable range estimating module for the electric vehicle according to claim 21, wherein the planned charging time is determined based on the specified time that is specified by a user, the specified time is a specified charging time duration or a specified charging finish-time, when the specified time is the specified charging time duration, the planned charging time is equal to the specified charging time duration, and when the specified time is the specified charging finish-time, the planned charging time is a result of a subtraction of the current time, the estimated driving time, and the estimated charging waiting time from the specified charging finish-time.

23. An electric vehicle driving assistance device comprising a micro-controller unit, the micro-controller unit comprising:
a vehicle dynamic analysis unit which detects a status of the electric vehicle itself to obtain the vehicle dynamic information, battery information of the electric vehicle;
an environment variable detecting unit which detects a status of the environment in which the electric vehicle is located to obtain the positioning information, map information, and traffic information;
a power supply facility selecting unit which receives the vehicle dynamic information, the battery information, the positioning information, the map information and the traffic information to thereby set a selecting range and acquires information associated with at least one power supplement location within the selecting range; and
the electric vehicle after-charge drivable range estimating module according to claim 21.

24. The electric vehicle driving assistance device according to claim 23, further comprising a charging device status updating interface for receiving the information associated with the at least one power supplement location.

25. The electric vehicle driving assistance device according to claim 24, wherein the charging device status updating interface is adapted to communicate with a charging service platform to obtain the information associated with the at least one power supplement location.

26. The electric vehicle driving assistance device according to claim 24, wherein the information associated with the at least one power supplement location comprises position, service time, number of the charging seats, average waiting time, and reserved time.

27. The electric vehicle driving assistance device according to claim 26, wherein the information associated with the at least one power supplement location further comprises number of vehicles in queue and number of reservations.

28. The electric vehicle driving assistance device according to claim 23, further comprising a database communication interface which receives and outputs the positioning information, map information and traffic information to the environment variable detecting unit.

29. The electric vehicle driving assistance device according to claim 23, further comprising a sensor and battery management system communication interface which receives and outputs the vehicle dynamic information and battery information to the vehicle dynamic analysis unit.

30. The electric vehicle driving assistance device according to claim 23, further comprising a display interface which displays the map information, the information associated with the at least one power supplement location, the estimated after-charge drivable range calculated by the after-charge drivable range estimating unit in a consolidated manner.

31. The electric vehicle driving assistance device according to claim 23, wherein the selecting range is specified by a user.

32. The electric vehicle driving assistance device according to claim 23, wherein the selecting range is determined according to a location and vehicle dynamic information of the electric vehicle.

33. The electric vehicle driving assistance device according to claim 23, wherein the selecting range is determined according to a location, a driving direction and vehicle dynamic information of the electric vehicle.

34. The electric vehicle driving assistance device according to claim 23, further comprising a vehicle dynamic information sensor, the vehicle dynamic information sensor comprises a gyroscope, a triaxle accelerometer and an electronic compass.
